(19) United States
(12) Patent Application Publication
(10) Pub. No.: US 2009/0106660 A1
(43) Pub. Date: Apr. 23, 2009

(54) Virtual film reader for digital cinema

(76) Inventors: John Robert Naylor, Lake Oswego, NJ (US); James Edward Pearce, Portland, OR (US); Merlin Ray Miller, Hillsboro, OR (US)

Correspondence Address: Robert D. Shedd;Thomson Licensing LLC, PO Box 5312, PRINCETON, NJ, 08543-5312, US

(21) Appl. No.: 11/989,663

(22) PCT Filed: Dec. 1, 2005
(86) PCT No.: PCT/US2005/043454

§ 371 Date: Jan. 29, 2008

(51) Int. Cl. G06F 3/048

(52) U.S. Cl. 715/731; 715/730

(57) ABSTRACT

A virtual film reader system and method includes a digital cinema server configured to render a presentation (124). A graphical user interface is coupled to the server which includes one or more virtual automation cue tracks (108) which define a temporal domain corresponding with the presentation (124). Cues (108) are positioned by a user employing the graphical user interface on the one or more tracks, the cues (108) corresponding to a time and duration of (104) the presentation (124) when an event is to occur.

### CROSS-REFERENCE TO RELATED APPLICATIONS

This application is related to U.S. Provisional Patent Application Ser. No. [TBD], entitled “VIRTUAL FILM READER FOR DIGITAL CINEMA”, filed Aug. 10, 2005, which is incorporated by reference herein in its entirety.

### FIELD OF THE INVENTION

The present invention generally relates to digital cinema servers, more particularly, to features of a digital cinema server that permit emulation of a mechanical film reader.

### BACKGROUND OF THE INVENTION

Cinema exhibition booths incorporate a rudimentary automation system where certain events can be programmed to occur at precise points in the presentation. Examples include curtains opening and closing, lights full, half, emergency exit only, etc. The cues for these and other events are “programmed” into the presentation by attaching small strips of aluminum tape to the film print at key points. The film runs through a film reader immediately before going into the projection gate. The film reader detects these automation cues, and other statuses such as whether film is present, and whether film is running. The cue and status information is presented to an automation system as electrical pulses on dedicated wires.

The traditional film reader can present, e.g., signals to the automation system to produce an appropriate action in accordance with the tape (cues) on the film. The cues are detected when the aluminum tape attached to the film causes current to flow between two sensors on a reader. The cues can be on either edge of the film, or in the center (inboard, outboard and center cues).

With advances in digital cinema, film will eventually be replaced as a distribution medium, and the present mechanical film viewer which integrates a projector with a cinema automation system will become obsolete. This has the disadvantage of rendering obsolete the existing automation systems currently deployed in up to 100,000 auditoria worldwide.

### SUMMARY OF THE INVENTION

A virtual film reader system and method include a digital cinema server configured to render a presentation. A display is coupled to the server to display the presentation, and the display includes a graphical user interface which includes one or more virtual tracks which define a temporal domain corresponding with the presentation. Cues are positioned by a user employing the graphical user interface on the one or more tracks. The cues correspond to a time and duration of the presentation when an event is to occur.

A virtual film reader system and method includes a digital cinema server configured to render a presentation. A graphical user interface is coupled to the server which includes one or more virtual automation cue tracks which define a temporal domain corresponding with the presentation. Cues are positioned by a user employing the graphical user interface on the one or more tracks, the cues corresponding to a time and duration of the presentation when an event is to occur.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is block diagram of an exemplary system for a theater or screen management system in a digital cinema in accordance with one embodiment;,

FIG. 2 is a diagram showing a graphical user interface screen having virtual tapes or cues disposed on tracks in accordance with one embodiment; and

FIG. 3 is a diagram showing pseudo-code for a virtual tape or cue in accordance with an illustrative embodiment; and

FIG. 4 is a block/flow diagram showing a method for applying and employing virtual tape or cues in a digital cinema.

It should be understood that the drawings are for purposes of illustrating the concepts of the invention and are not necessarily the only possible configuration for illustrating the invention.

### DETAILED DESCRIPTION OF THE INVENTION

Aspects of the present disclosure are directed to embodiments that provide systems and methods for embedding cues into digital presentations (e.g. start of show, first frame of presentation, etc).

It is to be understood that the present invention is described in terms of a digital cinema system; however, the present invention is much broader and may include any digital multimedia system, which is capable of delivering video images and cues.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

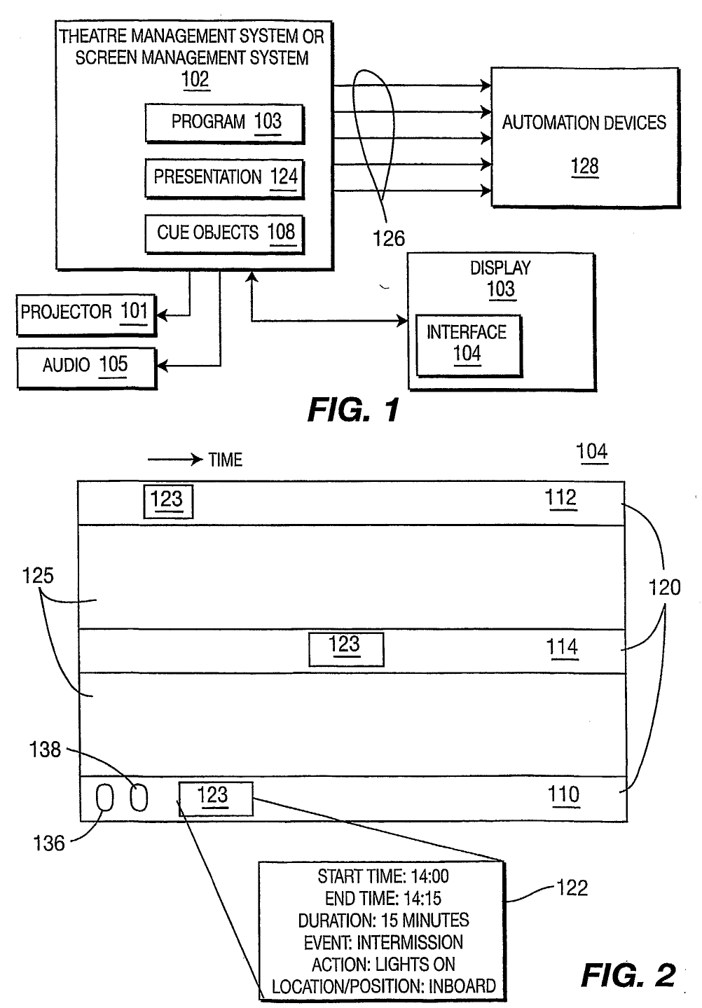

Referring now in specific detail to the drawings in which like reference numerals identify similar or identical elements throughout the several views, and initially to FIGS. 1 and 2, an illustrative system 100 includes a computer or equivalent digital rendering display device 102, such as e.g., a digital cinema server, theater management system or screen management system. Movie distribution and exhibition is currently in transition from using film as the distribution and exhibition medium to using digital media that are distributed as computer files and exhibited using digital cinema playout servers 102, digital projectors 101 and audio processors 105.

Digital cinema server 102 is configured to render a presentation 124. A display 103 is coupled to the server 102 to display the presentation 124. The display 103 includes a graphical user interface (GUI) 104 which includes one or more virtual tracks 120 which define a temporal domain corresponding with the presentation 124. Cues 123 are positioned by a user employing the graphical user interface 104 on the one or more tracks 120. The cues 123 correspond to a time and duration of the presentation 124 when an event (e.g., intermission, credits, etc.) is to occur.

Display 103 may include a computer monitor or other display device and is coupled to device 102. Display 103 displays graphical user interface 104 to permit interactivity between a user (e.g., a projectionist) and the system 100. A user is permitted to set the time and manner of cues relative to the presentation to be shown. Interface 104 may include touch screen controls, a keyboard, a mouse, digitizer, joystick or any other control that permits the user to view the display and move a cursor or other points of interest to be able to set virtual cues object 108. A program 130 may be provided which generates cue objects 108 in accordance with the user input information.

In one embodiment, GUI 104 includes a screen or window 116 having three tracks 120 displayed therein. The three tracks 120 may include an inboard track 110, an outboard track 112 and a center cue track 114. Each track 120 may run an entire length of the film or presentation. These tracks may be referred to generally as automation tracks 120. Virtual tapes or cues 123 may be placed by a user on the tracks 120 by a drag and drop method or by entering coordinates/parameters 123 such as time, duration, event and function (action) for that cue 123. Advantageously, the film images, reel segments or graphical representations of content tracks may be displayed in a center area 125 of display screen 116.

A film reader's functionality and usefulness are provided without adding aluminum tape to a film. Advantageously, a film reader is emulated by producing the exact signals that are currently deployed and recognized in automation systems. In accordance with one embodiment, operators may employ the graphical user interface (GUI) 104 to attach the virtual pieces of “aluminum tape” 123 to a representation of the presentation 124. The virtual pieces of tape 123 may be configurable to be stretched (increase/decrease duration) and may include a classification or function label for each cue, e.g., inboard, open curtains, etc. The system 100 converts these cues to the appropriate electrical signals 126 at the correct time as indicated by the location of the tape on the feature. Electrical signals 126 are output to appropriate automation devices 128 to implement the cued events (e.g., closing the curtains, opening doors, lights, etc.).

It should be understood that the virtual tapes 123 may be interactively and graphically configured by a user such that the basic feel and procedure of applying metal tape to a film is preserved without the time consuming and risky process of actually applying tape to a film.

The present invention provides seamless integration with legacy equipment since the same electrical signals 126 are employed to control equipment already in place. A traditional print reader provides established and reliable technology, is familiar to operate for projectionists and interfaces to existing automation plants. However, the traditional print reader relies on film as the exhibition medium, which is not compatible with digital cinema. In contrast, the virtual print reader 100 is not compatible with film, but permits for familiar operation by projectionists, directly interfaces to existing automation plants and is Digital Cinema Initiative (DCI) compliant.

DCI compliance, in this case, refers to Automation Programming sections of the standard. The Automation System is required to communicate events to and from the screen equipment. These can be light dimmers, curtains, or other systems within an auditorium. These events or cues are programmed within the theater management (TMS) or the screen management system (SMS), and initiated by either the SMS or the Automation depending on which unit is master and which is slave. All of the event types are pre-programmed to have certain effects on the system. These events, at a minimum, are required to be recognized by all systems and are listed as First Frame of Content, First Frame of Intermission, Last Frame of Intermission, First Frame of End Credits, First Frame of End Credits on Black, and Last Frame of Content.

In embodiments of the present invention, physically sticking aluminum tape to film is replaced by a GUI 104, which may be employed using a screen management system or a theater management system to control the theater's automation system 128.

A presentation 124 is shown on screen 116 and illustratively represented as a large rectangle, split into three cue tracks 120 to which cues 123 have been inserted by a user. By selecting a cue 123, the user can interrogate and edit details 123 such as the cue's location (inboard, outboard, and center), start time, duration, end time, function, add metadata, or input other information (e.g., who programmed the automation feature, when it was programmed, the theater name, type of theater.

The cues may be configured to take the shape of the event under its control, for example, a cue in the form of a light bulb may be employed to turn on or dim the lights of a theater, a cue shaped like a curtain may indicate a cue to open/close the curtains, etc. A database automation menu may be provided where a cue icon may be selected from a group of functions and placed on an automation track. The digital cinema server 102 may include general purpose outputs which may be selectable by the user for the cues 123. Film present 136 and film running signals 138 indicators may be provided on screen 116 to indicate the film is present and running respectively to remain consistent with legacy systems. The film present and film running signals are preferably driven by the server's system software, Film present 136 and film running 138 indicators may be placed anywhere on screen 116 to indicate to a projectionists that the film is present and running over a digital projector 101.

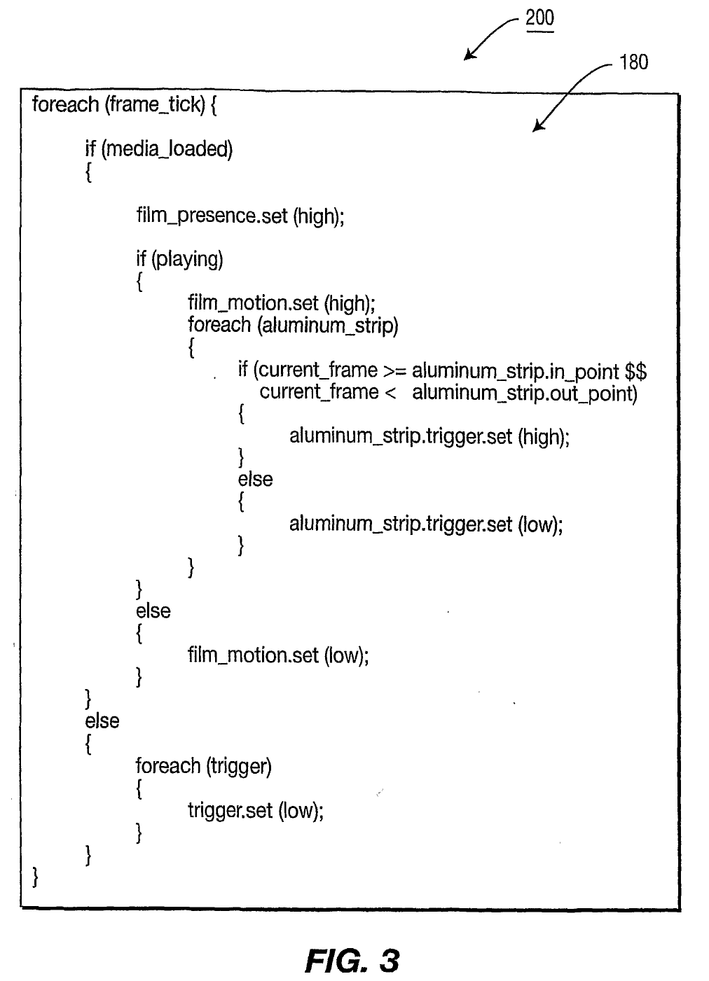

Referring to FIG. 3, a pseudo-code 200 illustratively demonstrates a control flow for processing a block responsible for triggering cues. In the pseudo-code example, an aluminum_strip class exists that encapsulates start and end points of virtual aluminum strips (123) applied via the GUI (104), as well as a reference to a trigger object that the strip sets. When a virtual strip is applied via the GUI, the system instantiates an aluminum_strip object, sets its start and end points appropriately, and assigns the trigger reference to one of the trigger objects illustratively listed below.

In this example, the pseudo code assumes the existence of five trigger objects (although fewer trigger objects or more trigger objects may be present). The five cues given match the cues that a traditional, physical film automation reader generates. The objects 108 include film_presence, film_motion, inboard_cue, outboard_cue, and center_cue. Note that the film_presence and film_motion triggers may be automatically set based on the playout status of the server.

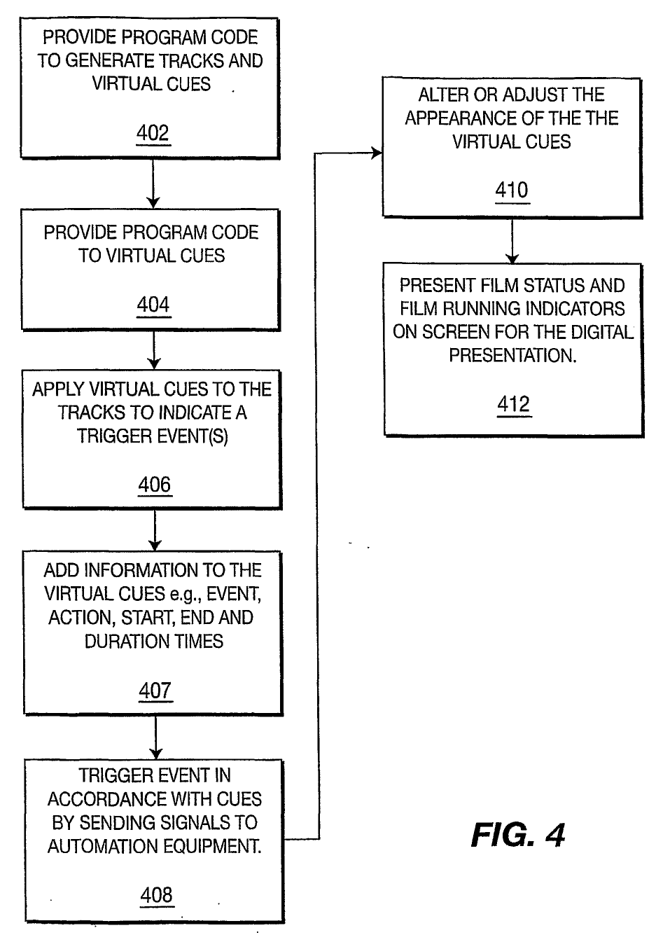

Referring to FIG. 4, a method for setting cues in a digital cinema system is illustratively shown. In block 402, a program code is provided on or to a server to generate one or more tracks against digital content of a presentation on a display. This may include generating virtual images of an inboard track, an outboard track and a center track. In block 404, programming code or objects for the cues are instantiated at the server to send signals to activate automation devices.

Using a graphical user interface in block 406, a virtual cue or cues are applied to the one or more tracks to temporally indicate when an event is to be triggered. The tracks may be presented on the display adjacent to content of the presentation. The virtual cue or cues may be dragged and dropped onto the one or more tracks. In block 407, each cue may be set by adding, e.g., a start time, an end time, duration, an event, an action and a cue position or any other information related to each cue.

In block 408, an event is triggered in accordance with the cue or cues. Triggering may include prompting the server to send signals to activate automation devices. The automation devices activated may include opening/closing curtains, adjusting lights adjusting a screen, etc. In block 410, indicating which automation devices the cues prompt using shaped or patterned cue icons may be provided. Cues and their appearance may be altered or adjusted in accordance with user preferences.

In block 412, a film present-status and a film running status may be presented on the display.

Having described preferred embodiments for virtual film reader for digital cinema (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A virtual film reader system comprising:
a digital cinema server configured to render a presentation;
a graphical user interface coupled to the server which includes at least one virtual automation cue track and
at least one cue positioned using the graphical user interface on at least one track, at least one cue corresponds to a time and duration of the presentation when an event is to occur.

2. The system as recited in claim 1, wherein at least one cue prompts the server to send signals to activate automation devices.

3. The system as recited in claim 2, wherein the automation devices include devices for operating devices in a theatre.

4. The system as recited in claim 1, wherein at least one cue includes an appearance indicating which automation device the cue prompts.

5. The system as recited in claim 1, wherein at least one track includes an inboard track, an outboard track and a center track.

6. The system as recited in claim 1, wherein at least one cue indicates one of a start time, an end time, and duration of an event.

7. The system as recited in claim 1, wherein at least one track is presented on the display adjacent to a representation of the presentation.

8. The system as recited in claim 1, wherein the display includes indicators for at least a film present status and a film running status.

9. The system as recited in claim 1, wherein at least one cue includes a programming object instantiated at the server to send signals to activate automation devices.

10. The system as recited in claim 1, wherein the system is Digital Cinema Initiative compliant.

11. A method for setting automation cues in a digital cinema system, comprising:
providing instruction to a server to generate at least one automation track against representations of digital content; and
applying at least one virtual cue to at least one track to indicate when an event is to be triggered.

12. The method as recited in claim 11, further comprising triggering an event in accordance with at least one cue.

13. The method as recited in claim 11, wherein applying the virtual cue or cues includes dragging and dropping the cue or cues onto the one or more tracks.

14. The method as recited in claim 11, further comprising setting one or more of a start time, an end time and a duration for each cue.

15. The method as recited in claim 12, wherein triggering includes prompting the server to send signals to activate automation devices.

16. The method as recited in claim 15, wherein the automation devices are activated for adjusting lights.

17. The method as recited in claim 11, further comprising indicating which automation devices the cues prompt using shaped or patterned cue icons.

18. The method as recited in claim 11, wherein providing instruction includes providing program code that includes generating an inboard track, an outboard track and a center track.

19. The method as recited in claim 11, wherein at least one track is presented on the display adjacent to a representation of content of the presentation.

20. The method as recited in claim 11, further comprising indicating a film present status and a film running status on the display.

21. The method as recited in claim 11, further comprising instantiating programming objects for at least one cue at the server to send a signal to activate automation devices.
